(19) United States
(12) Patent Application Publication
(10) Pub. No.: US 2017/0329113 A1
(43) Pub. Date: Nov. 16, 2017

(54) COMPACT FIVE-REFLECTION OPTICAL SYSTEM AS A UNITY MAGNIFICATION FINITE CONJUGATE RELAY

(71) Applicant: RAYTHEON COMPANY, Waltham, MA (US)

(72) Inventor: Lacy G. Cook, El Segundo, CA (US)

(21) Appl. No.: 15/153,397

(22) Filed: May 12, 2016

(51) Int. Cl. G02B 17/06; G02B 17/02; G02B 17/00

(52) U.S. Cl. CPC G02B 17/0663; G02B 17/008; G02B 17/023

(57) ABSTRACT

An optical system including a unity magnification, finite conjugate, all-reflective image relay configured to receive optical radiation representing an input image and to relay the optical radiation via five reflections to an output image plane to provide an output image at the output image plane, the output image being a unity magnification copy of the input image. In certain examples the optical system includes foreoptics configured to produce the input image. The foreoptics and the image relay can be telecentric.

### BACKGROUND

All-reflective optical systems are often used in certain imaging applications where chromatic aberrations, thermal behavior, size, weight, or cost restricts the use of refractive lenses. There are numerous applications in which it is necessary to relay the image formed at the output of such all-reflective optical systems to another location. For example, certain optical systems located on stabilized gimbals for pointing purposes may require an image relay to transfer the imagery to detector arrays located off gimbal. Such optical systems may also require image derotation devices to maintain constant image orientation as the gimbal is articulated. Although certain refractive (lens-based) image relays and derotation devices are known, the spectral restrictions and aberrations of a refractive approach are contrary to the preferred all-reflective nature of the initial optical system (also referred to as the foreoptics).

### SUMMARY OF INVENTION

Aspects and embodiments are directed to all-reflective optical systems and, more particularly, to a highly-symmetric all-reflective five-reflection relaying optical system. As discussed in more detail below, certain embodiments provide a compact all-reflective finite conjugate relaying optical system that can be used with certain all-reflective non-relayed telecentric imaging optical systems.

According to one embodiment an optical system comprises a unity magnification, finite conjugate, all-reflective image relay configured to receive optical radiation representing an input image and to relay the optical radiation via five reflections to an output image plane to provide an output image at the output image plane, the output image being a unity magnification copy of the input image.

In one example the unity magnification, finite conjugate, all-reflective image relay is telecentric.

In one example the unity magnification, finite conjugate, all-reflective image relay includes a primary mirror configured to receive and reflect the optical radiation, a secondary mirror configured to receive the optical radiation reflected from the primary mirror and to further reflect the optical radiation, a tertiary mirror configured to receive the optical radiation reflected from the secondary mirror and to further reflect the optical radiation, a quaternary mirror configured to receive the optical radiation reflected from the tertiary mirror and to further reflect the optical radiation, and a quintary mirror configured to receive the optical radiation reflected from the quaternary mirror and to reflect the optical radiation to the output image plane to provide the output image. In one example the primary mirror, the tertiary mirror, and the quintary mirror are positive powered, and the secondary mirror and the quaternary mirror are negative powered. In another example the optical powers of the primary mirror, the secondary mirror, the tertiary mirror, the quaternary mirror, and the quintary mirrors are selected to achieve a zero-Petzval-sum condition. In one example the primary mirror has a near-sphere surface figure, the secondary mirror has a hyperbolic surface figure, and the tertiary mirror has a near-sphere surface figure. In another example the quaternary mirror has a hyperbolic surface figure and the quintary mirror has a near-sphere surface figure.

In one example the unity magnification, finite conjugate, all-reflective image relay includes a first mirror, a second mirror, a third mirror, and a fourth mirror, the first mirror being configured to receive and reflect the optical radiation to the second mirror, the third mirror being configured to reflect the optical radiation to the second mirror, the second mirror being configured to reflect the optical radiation received from the first mirror to the third mirror and to reflect the optical radiation received from the third mirror to the fourth mirror, and the fourth mirror being configured to reflect the optical radiation to the output image plane to provide the output image. In one example the first, third, and fourth mirrors are positive powered, and the second mirror is negative powered. The optical powers of the first, second, third, and fourth mirrors may be selected to achieve a zero-Petzval-sum condition. In one example the first, third, and fourth mirrors each has a near-sphere surface figure, the second mirror has a hyperbolic surface figure.

In another example the unity magnification, finite conjugate, all-reflective image relay includes a first mirror, a second mirror, and a third mirror. In one example the first and third mirrors are positive powered, and the second mirror is negative powered. Then optical powers of the first, second, and third mirrors may be selected to achieve a zero-Petzval-sum condition. In one example the first and third mirrors each has a near-sphere surface figure, the second mirror has a hyperbolic surface figure.

The optical system may further comprise foreoptics configured to produce the input image. In one example the foreoptics is telecentric.

The optical system may further comprise a first fold mirror positioned between the foreoptics and the unity magnification, finite conjugate, all-reflective image relay, and a second fold mirror positioned between the unity magnification, finite conjugate, all-reflective image relay and the output image plane. In one example the first fold mirror, the unity magnification, finite conjugate, all-reflective image relay, and the second fold mirror are rotatable about an optical axis passing through a center of each of the first and second fold mirrors.

According to another embodiment an optical system comprises all-reflective foreoptics, optionally being telecentric, configured to produce an input image from received optical radiation, and a unity magnification, finite conjugate, all-reflective image relay configured to receive from the foreoptics the optical radiation representing the input image and to relay the optical radiation via five reflections to an output image plane to provide an output image at the output image plane, the output image being a unity magnification copy of the input image.

Still other aspects, embodiments, and advantages of these exemplary aspects and embodiments are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures is represented by a like numeral. For purposes of clarity, not every component may be labeled in every figure. In the figures:

FIG. 1 is a ray trace of one example of an optical system including foreoptics and a five-reflection image relay according to aspects of the present invention;

FIG. 2 is a ray trace of another example of a five-reflection image relay according to aspects of the present invention;

FIG. 3 is a table showing an optical prescription for one example of the five-reflection image relay of FIG. 1, according to aspects of the present invention; and

FIG. 4 is a ray trace of one example of an optical system configured as an image relay and derotation device according to aspects of the present invention.

### DETAILED DESCRIPTION

For certain all-reflective non-relayed telecentric imaging optical systems, such as the reflective triplet disclosed in U.S. Pa. No. 4,240,707 to Wetherell et al., the wide angle large reflective unobscured (WALRUS) telescope disclosed in U.S. Pat. No. 5,331,470 to Cook, or the all reflective real pupil telecentric imager disclosed in U.S. Pat. No. 8,714,760 to Cook, for example, there exists a need for a compact all-reflective finite conjugate relaying optical system. Aspects and embodiments disclosed herein provide that capability. As discussed in more detail below, certain aspect and embodiments are directed to a compact, highly-symmetric, all-reflective, unity magnification finite conjugate image relaying optical system that produces a telecentric final image that is essentially a 1× copy (in all aspects) of the image formed by the initial optical system. As discussed in more detail below, the 1× (unity) magnification and the symmetric nature of the relay that performs well with fast optical speeds and wide fields of view, the compactness of the relay, and the achievable image quality are all unique features that represent desirable improvements over existing relaying optical systems known in the art.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation.

According to certain embodiments, there is provided a highly-symmetric all-reflective five-reflection relaying optical system, which can be implemented using three, four, or five separate mirrors. As used herein the term “mirror” refers to a reflective surface, and each mirror may be implemented as either an individual structural element or an individual reflective coating or layer provided on a common structural base that supports two or more reflective surfaces. In certain embodiments the relaying optical system is advantageously used as a unity magnification finite conjugate relay of a telecentric intermediate image formed by an initial optical system (also referred to herein as “foreoptics”).

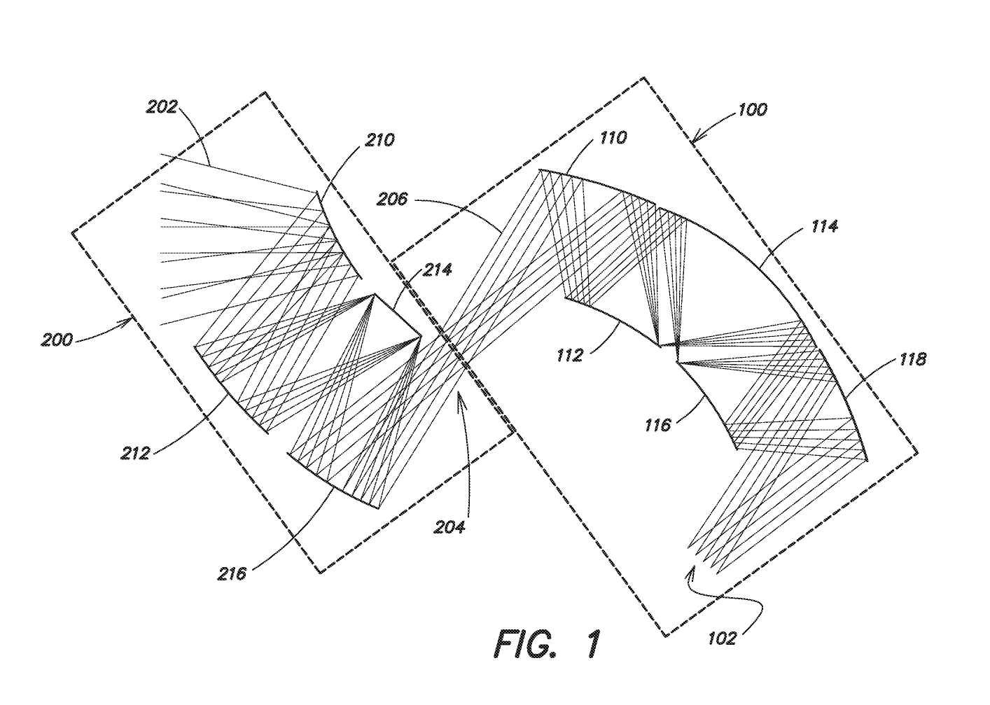

Referring to FIG. 1 there is illustrated one example of a unity magnification finite conjugate image relay 100 according to certain embodiments, used behind telecentric foreoptics 200. The foreoptics 200 receives optical radiation 202 from a viewed scene and outputs a telecentric intermediate image at an intermediate image plane 204. The image relay 100 receives that intermediate image and relays it, via five reflections, to an output image plane 102. As used herein the term “optical radiation” refers to electromagnetic radiation in the optical bands of the electromagnetic spectrum, generally including the ultraviolet, visible, and infrared spectral bands, extending roughly between wavelengths of 100 nm to 1 mm. Electromagnetic waves in this range obey the laws of optics. In the example shown in FIG. 1, the foreoptics 200 is a four-mirror wide angle large reflective unobscured system (WALRUS) design, such as that disclosed in U.S. Pat. No. 5,331,470. In this example, the foreoptics 200 includes a primary mirror 210, a secondary mirror 212, a fold mirror 214, and a tertiary mirror 216. The primary mirror 210 and secondary mirror 212 form a non-reimaging afocal telescope of the Galilean type at an afocal magnification of 2X. The fold mirror 214 is positioned to receive the beam of optical radiation from the secondary mirror 212 and reflect the beam to the tertiary mirror 216. The tertiary mirror 216 focuses and directs the beam to the intermediate image plane 204 to provide the intermediate image. The foreoptics 200 in this example of is from the WALRUS family, since it is a non-relayed four-mirror form with a mirror power distribution of negative, positive, positive (excluding the fold mirror which is unpowered) used on-axis in aperture and off-axis in field. However, the example of the foreoptics 200 shown in FIG. 1 is illustrative only and non-limiting. The image relay 100 according to various embodiments may be used with any telecentric foreoptics that provides an output intermediate image, not limited to the specific example shown in FIG. 1.

The image relay 100 is an all-reflective five-reflection finite conjugate image relay. As known to those skilled in the art, in a telescope, the subject focal plane is at infinity and the conjugate image plane, at which an image sensor (such as afocal plane array, for example) is placed, is said to be an infinite conjugate. In contrast, in the image relay 100, the intermediate image plane 204 (the subject focal plane in this example) is close to the optical elements (mirrors) of the relay, and therefore the output image plane 102 is said to be a finite conjugate. According to one embodiment, the image relay 100 includes a primary mirror 110, a secondary mirror 112, a tertiary mirror 114, a quaternary mirror 16, and a quintary mirror 118.

The primary mirror 110 is a positive power mirror and is positioned to receive the optical radiation 206 representing the intermediate image from the intermediate image plane 204. The surface of the primary mirror 110 has a near-sphere surface figure (shape).

The secondary mirror 112 is a negative power mirror and is positioned to receive the optical radiation 206 reflected from the primary mirror 110 and to reflect it to the tertiary mirror 114. The surface of the secondary mirror 112 has a hyperbolic surface figure. Together, the primary mirror 110 and secondary mirror 112 form a Cassegrain-like pair.

The tertiary mirror 114 is a positive power mirror and is positioned to receive the optical radiation 206 from the secondary mirror 112. The tertiary mirror 114 also reflects the optical radiation 206 to the quaternary mirror 116. The surface of the tertiary mirror 114 has a near-sphere surface figure.

The quaternary mirror 116 is a negative power mirror and is positioned to receive the optical radiation 206 reflected from the tertiary mirror 114 and to reflect it to the quintary mirror 118. The surface of the quaternary mirror 116 has a hyperbolic surface figure, and its optical surface may be substantially similar or identical to that of the secondary mirror 112.

The quintary mirror 118 is a positive power mirror and is positioned to receive the optical radiation 206 from the quaternary mirror 116 and to reflect it to the output image plane 102. The surface of the quintary mirror 118 has a near-sphere surface figure, and its optical surface may be substantially similar or identical to that of the primary mirror 110. In one embodiment, the optical powers of the primary mirror 110, secondary mirror 112, tertiary mirror 114, quaternary mirror 116, and quintary mirror 118 may be balanced to achieve a zero-Petzval-sum, or flat-field, condition at the output image plane 102.

The primary mirror 110, secondary mirror 112, tertiary mirror 114, quaternary mirror 116, and quintary mirror 118 may be formed using any of a variety of manufacturing processes and materials suitable to provide highly reflective, optical quality mirror surfaces. For example, the mirrors may be precision diamond machined out of aluminum, and optionally polished or coated to achieve the desired surface characteristics. As discussed above, the image relay 100 uses five reflections of the optical radiation 206 to relay the intermediate image from the intermediate image plane 204 to the output image plane 102 to provide the output image, and may be implemented using three, four, or five mirrors. FIG. 1 shows an example of a five-mirror implementation. In this example, all five reflections are from separate mirrors.

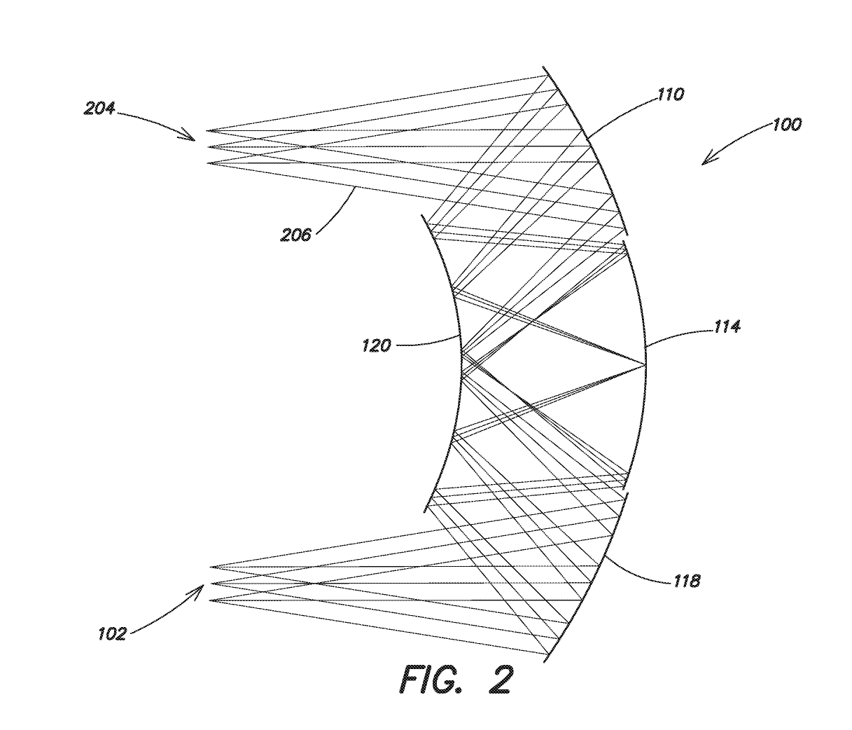

Referring to FIG. 2 there is illustrated an example of a four-mirror implementation of image relay 100. For the four mirror implementation, either the first and fifth reflections, or the second and fourth reflections share a common mirror. In the example shown in FIG. 2, the second and fourth reflections share a common mirror 120. In this example, the secondary mirror 112 and quaternary mirror 116 of the example shown in FIG. 1 are replaced by the common mirror 120. The mirror 120 has a hyperbolic surface figure.

For a three mirror implementation, the first and fifth reflections share a common mirror, as do the second and fourth reflections. Thus, in addition to the first common mirror 120 shown in FIG. 2, the primary mirror 110 and quintary mirror 118 can be replaced by a second common mirror (not shown). This second common mirror may have an annular shape, for example, to provide reflective surfaces corresponding to the primary mirror 110 and quintary mirror 118 for the first and fifth reflections, and having a central opening to accommodate the tertiary mirror 114, similar to the arrangement shown in FIG. 2. As discussed above, as an alternative arrangement to that shown in FIG. 2, a four-mirror implementation may instead replace the primary mirror 110 and quintary mirror 118 with a common mirror, as described above, used in conjunction with the secondary mirror 112, tertiary mirror 114, and quaternary mirror 116.

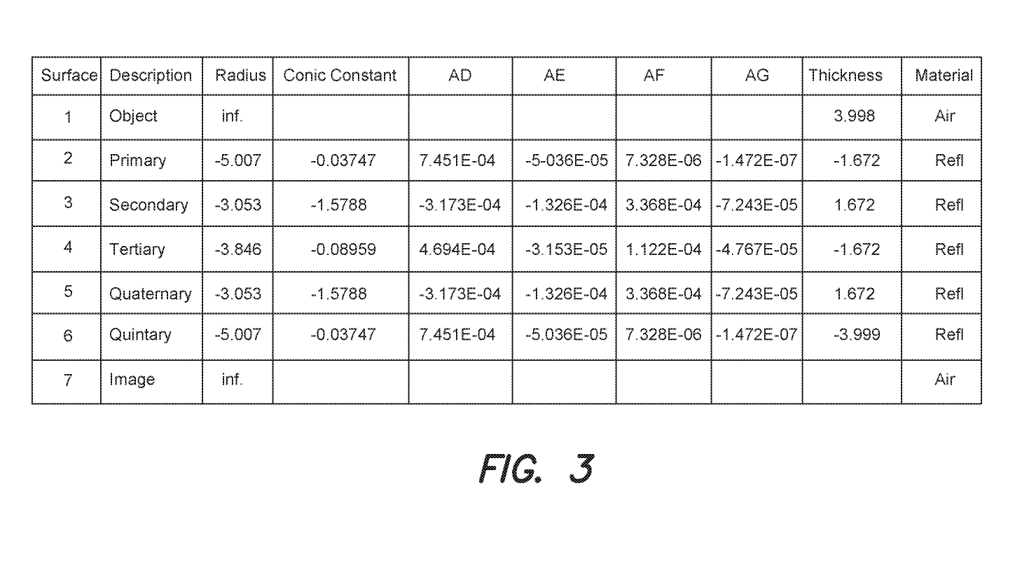

A specific optical prescription for one example of the image relay 100 in accordance with an illustrative embodiment corresponding to the implementation shown in FIG. 1 is provided in the table shown in FIG. 3. The “object” corresponds to the intermediate image located at the intermediate image plane 204. In this illustrative embodiment, the object and output image (at output image plane 102) diameters are 0.326 inches. The object and output image optical speeds are F/2.84. The object and output image lateral offsets are 2.204 inches. The image relay is telecentric. The optical prescription for this illustrative embodiment may be generated using an equation which is an industry standard and which would be known to those skilled in the art. In the table of FIG. 3, all units are inches. For the radius of the specific surfaces, the minus sign indicates that the center of curvature is to the left of the mirror surface. The conic constant is equal to the negative squared value of the eccentricity of a conic section (a planar cut through a double sheeted conic surface). The columns designated AD, AE, AF and AG are the aspheric constants of the specific surfaces.

The ray traces of the image relay 100 shown in FIGS. 1 and 2 may appear visually similar to the optical form shown in U.S. Pat. No. 5,078,502 to Cook (“the ‘502 patent); however, there are significant structural and functional differences between these two very different optical systems.

The ‘502 patent discloses an all-reflective afocal pupil relay which provides reimaging and derotation of collimated radiation received by the device. As explained in the '502 patent, the system receives light directed into an entrance aperture 20 (an entrance pupil) and relays the light to an exit aperture 22 (exit pupil), which is an image of the entrance aperture 20 as formed by the various mirror surfaces within the system. In particular, the quaternary and quintary mirrors 16 and 18 recollimate the rays 30 as they are reflected from the tertiary mirror 14, and thus the pupil relaying system is afocal (it receives and outputs collimated radiation). According to the '502 patent, the system achieves excellent pupil image quality.

Thus, the '502 patent discloses an afocal pupil relay, whereas aspects and embodiments disclosed herein provide a finite conjugate image relay. In the '502 patent, the entrance aperture 20 and exit aperture 22 are pupils, not images. Thus, the optical system disclosed in the '502 patent can be used as a stand-alone optical system. It receives and outputs collimated light. In contrast, the image relay 100 according to embodiments of the present invention requires foreoptics, such as the foreoptics 200, for example, to produce the input image which is then relayed to the output image plane 102 and provided as the output image. The '502 patent describes features and characteristics such as field-of-view and pupil location, whereas embodiments of the image relay 100 disclosed herein can be characterized in terms of image locations and optical speed. These differences are directly attributable to the fundamental different nature and purpose of the system of the '502 patent (an afocal pupil reimager) versus the finite conjugate image relay disclosed herein.

The optical prescription of the illustrative example of the image relay 100 provided in FIG. 3 has been scaled for direct comparison to the optical prescription given in the '502 patent for the afocal pupil relay/reimager. Due to the scale, symmetry of the designs, and the zero-Petzval-sum condition, the radii and spacings are similar, as may be seen by comparing the table shown in FIG. 3 with Table 1 of the '502 patent. However, the conic departures of the mirrors are very different, as shown in Table 1 below. This conic difference is a consequence of the correction for collimation in the '502 patent, in contrast to correction for image fidelity in the image relay 100 according to embodiments of the present invention.

TABLE 1

| | Conic | Conic |
|---|---|---|
| | Constant | Constant |
| Mirror | FIG. 3 | 5,078,502 |
| Primary | −0.03747 | −0.80176 |
| Secondary | −1.5788 | −4.4126 |
| Tertiary | −0.08959 | −0.68536 |
| Quaternary | −1.5788 | −4.4126 |
| Quintary | −0.03747 | −0.80176 |

Thus, the mirror surface figures of the mirrors of the image relay 100 and the afocal pupil relay of the '502 patent are significantly different. In the image relay 100, the first three mirrors are a near-sphere, a hyperbola, and a near-sphere, as discussed above. In contrast, the first three mirrors of the '502 patent are a strong ellipse, a strong hyperbola, and a strong ellipse.

As discussed above, certain optical systems that have use of an image relay also require an image derotation device. For example, certain optical systems located on stabilized gimbals for pointing purposes may require an image relay to transfer the imagery to detector arrays located off gimbal, along with an image derotation device to maintain constant image orientation as the gimbal is articulated. According to certain embodiments, the image relay 100 can be modified with two fold mirrors to provide a derotation function in addition to acting as a unity magnification, finite conjugate image relay.

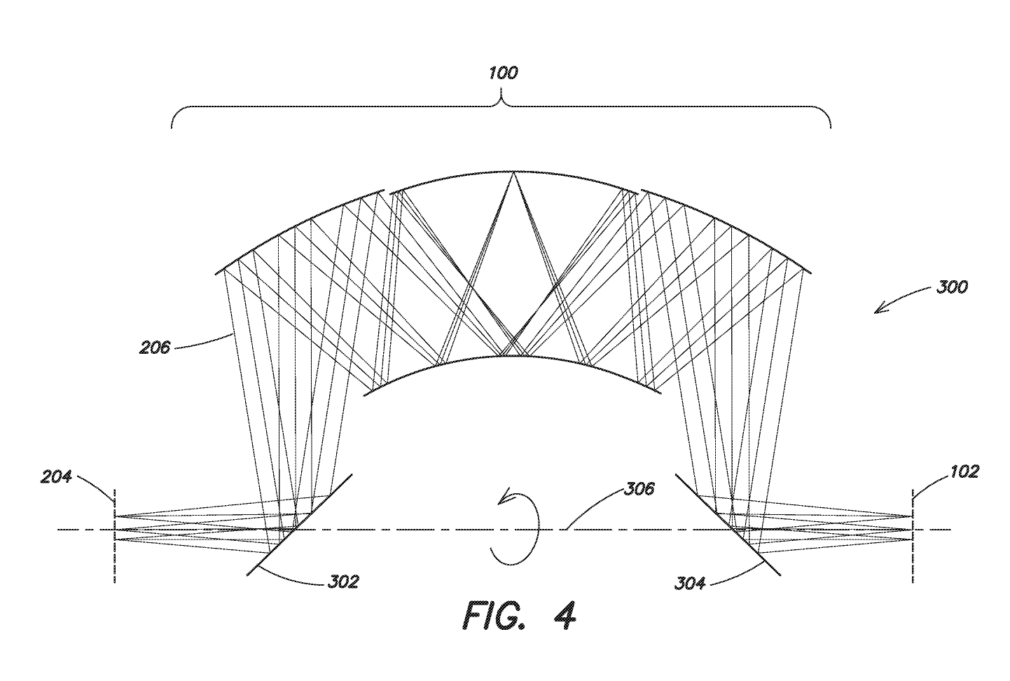

Referring to FIG. 4 there is illustrated an example of a combined image relay and derotation optical system 300 according to one embodiment. In this example, the optical system 300 includes two planar mirrors, namely a first fold mirror 302 and a second fold mirror 304, positioned on either side of the image relay 100. The fold mirrors 302 and 304 fold the optical radiation 206 as it enters and exits the image relay 100. In one example the fold mirrors 302 and 304 are positioned to be aligned with the intermediate image plane 204 (also referred to as the object plane) and the output image plane 102, respectively. The system can be rotated about an axis 306 that extends between the object and image planes 204, 102, respectively. Referring to FIG. 4, the system can be rotated out of the page as indicated by the arrow. Derotation of the image is obtained by rotation of the system about the axis 306. The image which is relayed by the system (and provided at the output image plane 102) rotates at twice the rate of rotation of the system.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. An optical system comprising:
a unity magnification, finite conjugate, all-reflective image relay configured to receive focused optical radiation representing an input image and to relay the optical radiation via five reflections to an output image plane to provide an output image at the output image plane, the output image being a unity magnification copy of the input image.

2. The optical system of claim 1 wherein the unity magnification, finite conjugate, all-reflective image relay is telecentric.

3. The optical system of claim 1 wherein the unity magnification, finite conjugate, all-reflective image relay includes:
a primary mirror configured to receive and reflect the optical radiation;
a secondary mirror configured to receive the optical radiation reflected from the primary mirror and to further reflect the optical radiation;
a tertiary mirror configured to receive the optical radiation reflected from the secondary mirror and to further reflect the optical radiation;
a quaternary mirror configured to receive the optical radiation reflected from the tertiary mirror and to further reflect the optical radiation; and
a quintary mirror configured to receive the optical radiation reflected from the quaternary mirror and to reflect the optical radiation to the output image plane to provide the output image.

4. The optical system of claim 3 wherein the primary mirror, the tertiary mirror, and the quintary mirror are positive powered, and the secondary mirror and the quaternary mirror are negative powered.

5. The optical system of claim 4 wherein optical powers of the primary mirror, the secondary mirror, the tertiary mirror, the quaternary mirror, and the quintary mirrors are selected to achieve a zero-Petzval-sum condition.

6. The optical system of claim 3 wherein the primary mirror has a near-sphere surface shape, the secondary mirror has a hyperbolic surface shape, and the tertiary mirror has a near-sphere surface shape.

7. The optical system of claim 6 wherein the quaternary mirror has a hyperbolic surface shape and the quintary mirror has a near-sphere surface shape.

8. The optical system of claim 1 wherein the unity magnification, finite conjugate, all-reflective image relay includes a first mirror, a second mirror, a third mirror, and a fourth mirror, the first mirror being configured to receive and reflect the optical radiation to the second mirror, the third mirror being configured to reflect the optical radiation to the second mirror, the second mirror being configured to reflect the optical radiation received from the first mirror to the third mirror and to reflect the optical radiation received from the third mirror to the fourth mirror, and the fourth mirror being configured to reflect the optical radiation to the output image plane to provide the output image.

9. The optical system of claim 8 wherein the first, third, and fourth mirrors are positive powered, and the second mirror is negative powered.

10. The optical system of claim 9 wherein optical powers of the first, second, third, and fourth mirrors are selected to achieve a zero-Petzval-sum condition.

11. The optical system of claim 8 wherein the first, third, and fourth mirrors each has a near-sphere surface shape, the second mirror has a hyperbolic surface shape.

12. The optical system of claim 1 wherein the unity magnification, finite conjugate, all-reflective image relay includes a first mirror, a second mirror, and a third mirror.

13. The optical system of claim 12 wherein the first and third mirrors are positive powered, and the second mirror is negative powered.

14. The optical system of claim 13 wherein optical powers of the first, second, and third mirrors are selected to achieve a zero-Petzval-sum condition.

15. The optical system of claim 12 wherein the first and third mirrors each has a near-sphere surface shape, the second mirror has a hyperbolic surface shape.

16. The optical system of claim 1 further comprising foreoptics configured to focus incident optical radiation to produce the input image.

17. The optical system of claim 16 wherein the foreoptics is telecentric.

18. The optical system of claim 16 further comprising a first fold mirror positioned between the foreoptics and the unity magnification, finite conjugate, all-reflective image relay, and a second fold mirror positioned between the unity magnification, finite conjugate, all-reflective image relay and the output image plane.

19. The optical system of claim 18 wherein the first fold mirror, the unity magnification, finite conjugate, all-reflective image relay, and the second fold mirror are rotatable about an optical axis passing through a center of each of the first and second fold mirrors.

20. An optical system comprising:
all-reflective foreoptics configured to receive and focus optical radiation to produce an input image from the received optical radiation; and
a unity magnification, finite conjugate, all-reflective image relay configured to receive from the foreoptics the focused optical radiation representing the input image and to relay the optical radiation via five reflections to an output image plane to provide an output image at the output image plane, the output image being a unity magnification copy of the input image.
